(19) United States
(12) Patent Application Publication
(10) Pub. No.: US 2012/0109748 A1
(43) Pub. Date: May 3, 2012

(54) SYSTEM AND METHOD FOR PRESENTING CONTENT TO CONSUMERS

(75) Inventor: Timo AHOPELTO, Helsinki (FI)

(73) Assignee: CVON INNOVATIONS LTD, LONDON (GB)

(21) Appl. No.: 13/010,848

(22) Filed: Jan. 21, 2011

Related U.S. Application Data
(63) Continuation of application No. PCT/EP2009/062713, filed on Sep. 30, 2009.
(60) Provisional application No. 61/194,715, filed on Sep. 30, 2008.

(51) Int. Cl. G06Q 30/02

(52) U.S. Cl. 705/14.53; 705/14.66

(57) ABSTRACT

System and method for presenting content, in the form of elements, from a content provider to a consumer in which the elements to present to the consumer and an order of presentation, if multiple elements are to be presented, are determined based on information about the consumer. In the advertising context, the elements are marketing messages so that each consumer is presented with a customized message flow. One of the marketing messages may be a question which elicits a response from the consumer, with subsequent marketing messages and/or the order thereof being determined based on the consumer's response.

### CROSS REFERENCE TO RELATED APPLICATIONS

This is a continuation application of International Application No. PCT/EP2009/062713, filed on Sep. 30, 2009, which claims the priority of U.S. Provisional Application Ser. No. 61/194,715, filed Sep. 30, 2008, the entire content of each of which is incorporated herein by reference.

### FIELD OF THE INVENTION

The present invention relates generally to systems and methods for presenting content, such as marketing messages, commercials and advertisements, to consumers and more specifically to systems and methods for delivering and presenting content to consumers which is customized for each consumer.

The present invention also relates to systems and methods for delivering and presenting content to consumers' mobile devices and coordinating the delivery and presentation of the content to the consumers' mobile devices using telecommunication infrastructure.

### BACKGROUND INFORMATION

Digital media enables two-way or bi-directional messaging and is therefore a unique advertising environment, in comparison to traditional mass media such as television, radio and print, and to online Internet advertising, which includes banners, search sponsorship and content sponsorship, which rely on uni-directional messaging, i.e., the directing of a message from an advertiser or its agent to the consumer without any communication from the consumer. Specifically, two-way messaging provides the capability to open a dialog between an advertiser and a consumer.

Typically, advertising campaigns using two-way messaging include several means for advertising and delivering messages to consumers' mobile terminals, as well as other digital terminals and devices that enable the consumers to generate a response, and other devices that present audio and/or visual content to the consumer, such as interactive television. In digital mobile terminals, consumers can be contacted using, for example, Short Message Service (SMS) messages and Multimedia Message Services (MMS) messages.

Another technique for conducting an advertising campaign utilizing two-way messaging allows for a creative design and flow of the campaign which varies based on the consumer's responses. In such advertising campaigns, the exchange between the advertiser and the consumer varies from a simple push information message from the advertiser, such as “This soft drink makes you feel good”, to a complex question/answer message flow or exchange. An exemplary message flow or exchange would be an initial, leading question presented by the advertiser to the consumer, such as “Do you prefer soft drinks with sugar or sugar-free?”, followed by different messages based on the consumer's response to the initial question. For this exemplary initial questions, and expected responses of “with sugar” or “sugar-free”, subsequent messages from the advertiser could include, for example “Show this e-coupon at your local store to get 25% of your purchase of sugar-free soft drink” and “Show this e-coupon at your local store to get 25% of your purchase of traditional taste, real soft drink”.

The rules and parameters for delivering and presenting the messages and creative format of the advertising campaign are usually determined by one or more of the advertiser, an advertiser broker or a service provider, e.g., the provider of telecommunications services to the consumer or the provider of the television content to the consumer.

One issue which arises with this type of advertising campaign is that it is difficult to determine the optimum message flow and creative format which provides the most effective

advertising, i.e., generates the intended response from the targeted consumers (usually purchase of an advertised product or service). That is, it is difficult to determine an appropriate and effective approach when formulating and sending messages to a multitude of consumers, which is even more difficult since consumer preferences vary considerably from one consumer to another. For example, while some consumers prefer a direct approach (e.g., receiving only direct push message such as “Get 20% off on soft drink.”), other consumers dislike the direct approach and want to be able to first select if they are interested in receiving such messages (e.g., receive an initial question in a message such as “Interested in minimum 20% offers for soft drinks?”), i.e., an indirect approach.

To address this issue, the personnel creating the advertising campaign define the marketing messages of the advertising campaign, i.e., the creative format and messaging flow, based on the best available knowledge of the behavior of the targeted consumers, if available, and the general perception of what could work for the advertising campaign being created, which is often based on their experience. After the creative work is completed, the marketing messages of the advertising campaign and their order of presentation, i.e., the message flow, are programmed into advertising delivery systems which proceed to deliver and present the marketing messages in accordance with the message flow. A drawback of advertising campaigns using such message flows is that the flows are static, i.e., not based on variable responses from the consumers, or there are limited options for different approaches for the flow.

It would therefore be desirable to enable the formation and use of multiple messages flows, i.e., variable combinations of marketing messages of an advertising campaign, with the specific message flow customized for each consumer.

### SUMMARY OF THE INVENTION

The present invention is directed at least in part to a system and method that customizes the delivery and/or presentation of elements of content in a digital two-way media to each targeted consumer based on information about each consumer. The information about the consumer may be information about their responses or reactions to preceding presentations of content, i.e., which presentation they most favorably react or respond to. To this end, a system and method in accordance with the invention enable the message flow or order of elements of content, which may include questions, messages and/or coupons, to be determined based on targeted consumers' profiles. Therefore, each consumer receives a presentation of elements of content in a form which they may respond to best. In addition to the consumers being satisfied in this manner, advertisers are also satisfied because the consumers receive content in a manner which is most likely to elicit a favorable response to the advertising campaign.

### BRIEF DESCRIPTION OF THE DRAWINGS

The invention, together with further objects and advantages thereof, may best be understood by reference to the following description taken in conjunction with the accompanying drawings, wherein like reference numerals identify like elements, and wherein:

FIG. 1 shows an arrangement of a system in accordance with the invention for presenting content to a consumer.

FIG. 2 is a prior art flow diagram showing the manner in which elements of content, specifically marketing messages relating to an advertised product or service, are delivered and presented to a consumer.

FIG. 3 shows a management system in accordance with the invention which determines which elements of content and their order to present to a consumer.

### DETAILED DESCRIPTION OF THE INVENTION

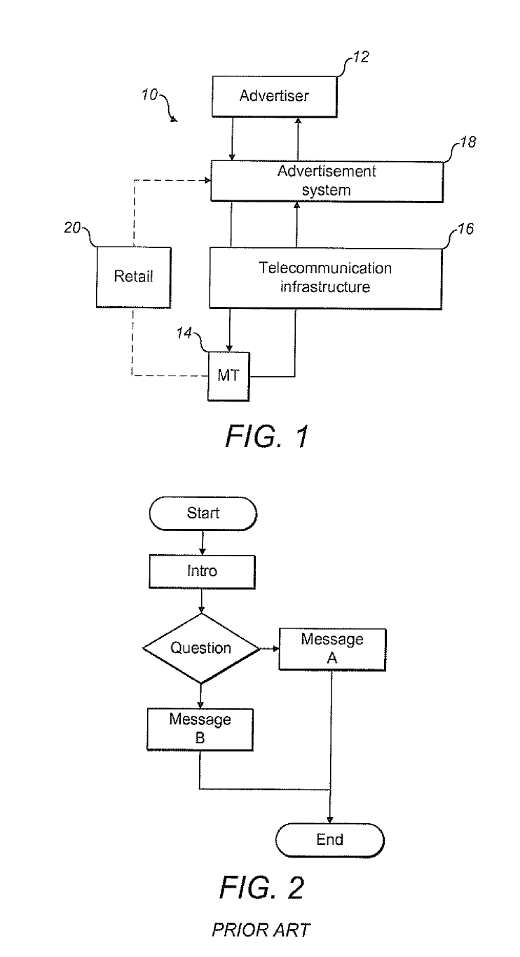

Referring to the accompanying drawings wherein the same reference numerals refer to the same or similar elements, FIG. 1 shows an arrangement of a system 10 in accordance with the invention for presenting content to a consumer while enabling the manner in which the content is presented to be customized for the consumer.

The content is provided by a content provider, an advertiser 12 when the system 10 is used to create and implement an advertising campaign. In the following description, the content provider is referred to as an advertiser but it should be understood that the content provider may be other than an advertiser.

An advertiser is defined to include any and all entities or individuals that want to advertise products or services to consumers. Advertisers can thus refer to a brand owner, a service provider, an advertisement agent, a merchant or any other party that wants to provide content to consumers. The content includes various elements and in the advertising context, the elements of the content are referred to herein as marketing messages. Marketing messages can be commercial advertisements, such as a product or service promotion, or non-commercial, such as a general information service notification. An advertiser can also be a store having a physical presence, an on-line store and the like, which sell or deliver goods and provide services directly to the consumers ordering via the Internet.

The marketing messages provided by the advertiser 12 are presented to the consumer on, for example, a presentation device, such as a terminal 14. Although only a single terminal 14 is shown in FIG. 1, the system 10 may include a plurality of mobile terminals 14, whether owned by the same consumer or different consumers. Each terminal 14 may be any form of mobile or other type of terminal such as a mobile telephone, a smart telephone, a multimedia computer, a personal digital assistant (PDA), a laptop computer, or a personal computer. At a minimum, the terminal 14 has the capability to communicate with one or more different types of communications networks and have messaging capabilities in the form of a messaging client system such as a short message service (SMS) client system, an e-mail client system, or a multimedia message service client system embedded in the terminal 14.

The terminals 14 may also be an interactive television or other visual and audio presentation device which presents visual and/or audio components to a consumer, and enables the consumer to interact therewith.

The terminal 14 is typically connected to telecommunications equipment or a telecommunication infrastructure 16 by means of a wireless and/or wired communication link. Using the telecommunication infrastructure 16, two-way or bi-directional communications are possible, i.e., transmission of marketing messages from the advertiser 12 to the terminal 14 and transmission of information and commands generated at the terminal 14 to the advertiser 12.

When the terminal 14 is a mobile terminal, telecommunication infrastructure 16 can utilize any cellular network technologies which include, but are not limited to, GSM, WCDMA, CDMA, 3G, 2G and GPRS. In addition to traditional cellular networks, local area networks such as Wireless Local area networks (WLAN), BlueTooth (BT) and other technologies such as WiMax, Broadcasting over DVB-H, ISDB-T, MediaFlo, DMB or broadcasting over cellular can be used, e.g., to deliver marketing messages to the terminals 14. The telecommunication infrastructure 16 can also be a generic Internet access network using any data transport methods. Moreover, the telecommunication infrastructure 16 may be any cellular, broadcast, wide area, local area or Internet network. Telecommunication infrastructure 16 can also be a combination of different communications networks such as a Wireless Local Area Network (WLAN) and a Wideband Code Division Multiplex (WCDMA) network. Using the foregoing network(s), the marketing messages from the advertiser 12 can be SMS, MMS, WAP Push, Web pages, or any digital object.

To control the presentation of the marketing messages from the advertiser 12 on the terminal 14, and also the delivery of the marketing messages to the terminal 14 via the telecommunication infrastructure 16, the system 10 includes a management system 18. Management system 18 generally receives or accesses a plurality of marketing messages provided by the advertiser 12, receives information about the consumer to which one or more of the marketing messages are to be presented, determines which marketing message or messages are to be presented to the consumer and an order of the marketing messages when multiple marketing messages are to be presented based on the received information about the consumer and communicates with the consumer to deliver and/or present the marketing messages in the determined order.

The advertiser 12 creates suitable marketing messages to be directed to consumers and creative work for the messages, e.g., pictures and music. The marketing messages may include introductions to the advertising campaign, questions designed to elicit a response from the consumer about one of their preferences, and messages containing coupons or offers for advertised products or services. The marketing messages would be provided by the advertiser 12 to the management system 18, e.g., using an interface. In one embodiment, the system 10 would be Internet-accessible so that the advertiser 12 may access the management system 18 using an Internet interface to provide the marketing messages, and also to create and manage advertising campaigns.

To this end, the management system 18 includes tools for each advertiser 12 to define rules and parameters of their advertising campaign, i.e., to enable them to tailor the advertising campaign to their specific desires. This may include reserving, programming and/or booking an advertising campaign via an Internet interface. Parameters which are determined by each advertiser 12 include, but are not limited to, the time period or periods when to send marketing messages, the duration of the advertising campaign, the target consumer or consumers, demographics of the target consumers, the format or type of marketing message, the target feedback level of the marketing message, the sociological background of the target consumer(s),

and demographics of the target consumer(s) including, for example, age, sex and income level(s).

The operator of the management system 18 might be a company in the business of delivering advertisements from several advertisers 12, i.e., it is an intermediary between advertisers 12 and the operators of the advertisement distribution channels.

Marketing messages from the management system 18 are delivered to the consumer's terminals 14 via telecommunication infrastructure 16 either in a determined order, or with instructions to present them in the determined order. Such marketing messages may also be delivered to other systems and infrastructure, such as to Web-based services and Internet pages.

In addition to enabling the delivery of marketing messages from each advertiser 12 to the terminal 14, the telecommunication infrastructure 16 also enables delivery of feedback from the terminal 14 to the management system 18 and to each advertiser 12. The feedback may be provided directly from the terminal 14 to the advertiser 12 or indirectly, for example, via the management system 18. Another feedback channel involves the integration of one or more retail processing systems 20, only one of which is shown, which provide confirmation of the purchase of a product, which is the subject of a marketing message, to the management system 18 or directly to the advertiser 12.

To determine which marketing messages are to be presented to the consumer and an order of the marketing messages based on the received information about the consumer, the management system 18 considers information about the consumer in the form of direct feedback and/or indirect feedback.

In an embodiment utilizing direct feedback or direct responses by a consumer when determining which marketing messages to deliver and present to the consumer, the consumer's response to a question, or other action with regard to a previously presented marketing message or advertising campaign is analyzed and determines the manner in which subsequent marketing messages are delivered and/or presented to the consumer (either which marketing message(s) and/or the order of marketing messages). Direct feedback may be provided by consumers in numerous ways and each type of feedback may be used independently of or in combination with one or more other types of feedback to determine the marketing message(s) to send.

For example, to provide direct feedback, the consumer may answer a question received via Short Message Service (SMS) message, click a link in a received message or browse in certain web/WAP pages. The consumer might also provide direct feedback by redeeming a coupon at a retail or Internet store so that data accumulated from external coupon monitoring systems, such as Point-Of-Sale systems, may be stored in a database accessible to the management system 18, and possibly even resident in the management system 18. The data about the redeemed coupons would be stored in association with each consumer so that when the management system 18 initiates a step wherein it determines a marketing message or order of marketing messages to deliver and present to a particular consumer, it would first access the database to see if the same consumer has previously redeemed coupons and if so, obtain the data about the coupons being redeemed and use this data to determine the marketing message(s) and other thereof.

In addition to or instead of using direct feedback from the consumers to determine the marketing messages to deliver and/or present to each consumer and the order thereof, it is possible to use indirect feedback about the consumer. Indirect feedback is information about the consumer, e.g., the behavior, which does not come from the consumer consciously undertaking an action in response to a marketing message, e.g., answering a question, buying the advertised product, etc. Generally, indirect feedback is from a source other than the consumer.

Indirect feedback may be obtained in several different ways. For example, the consumer's activities may be monitored to obtain or derive information about the consumer, including the consumer's interaction with and use of the telecommunication infrastructure 16. Specifically, the management system 18 may obtain indirect feedback about each consumer by interacting with the telecommunication infrastructure 16 to obtain information about the consumer's use of the telecommunication infrastructure 16, such as the duration of the consumer's phone calls, the speed at which the consumer responds to messages received from any source, the length of a typical response, the time to answer to incoming phone calls, the differential between incoming and outgoing phone calls, the diversity or variety of phone calls,

the types of messages being targeted to the consumer and how many different numbers are called. The foregoing merely exemplify different aspects of information about a consumer's activities, and specifically the consumer's interaction with and use of the telecommunication infrastructure 16, and the invention encompasses other aspects of information about the consumer obtained indirectly whether using telecommunication infrastructure 16 or otherwise. For example, information about the consumer's activities may be obtained using the retail processing system 20.

Once information about the consumer is obtained, and possibly stored in one or more databases accessible to the management system 18 or resident thereon, analysis tools may be used to categorize the consumer. After categorizing consumers, the management system 18 assigns specific marketing messages and an order of marketing messages to each category of consumer.

For example, one category may be the consumer's average response time to incoming messages sent to the consumer, e.g., an SMS message. If the message response time is relatively short (i.e., the consumer responds to the incoming message quickly), then the consumer may be categorized in a category of “likely to answer SMS messages in rapid fashion”. Then, if during an advertising campaign conducted by the management system 18, the same consumer is sent an SMS message with a question about a product or service and the consumer does not respond within a predetermined time period, it may be considered that the message, and thus the product or service identified therein, is not likely to be interesting for that consumer.

As another example, if a consumer is determined to only rarely respond to SMS messages, regardless of their source, the consumer may be categorized in a category of “unlikely to answer SMS message” and therefore the management system 18 would not send any marketing messages via SMS to this consumer.

FIG. 2 is a flow diagram showing the manner in which one of a plurality of different marketing messages would be delivered to the consumer's mobile terminal based on their direct feedback, i.e., their response to a question, in accordance with a prior art embodiment. Different marketing messages would be created by the advertiser and provided to an advertisement management system which would include appropriate software and computer programs to select the order of marketing messages to deliver and present to each consumer. For example, the computer program may generate an introduction to be delivered and presented to the consumer, such as “Coca Cola is it” if Coca Cola is the advertised product, and a question such as “Sugar or sugar-free?” (meaning whether the consumer wants “regular” Coca Cola with sugar or Diet Coca Cola without sugar. Based on the consumer's response to the question, a coupon is delivered and presented to the consumer. Thus, if the consumer responds with a message “Sugar”, they receive Message A which includes a coupon for regular Coca Cola and if the consumer responds with a message “Sugar-free”, they receive Message B which includes a coupon for Diet Coca Cola.

The foregoing prior art technique is static in that it provides for a predetermined, fixed flow of marketing messages to the consumer. The consumer is limited to one of two different responses to a question and each response causes a single, predetermined marketing message to be delivered and presented to the consumer.

On the other hand, the present invention provides a dynamic exchange between the management system 18 and each consumer (via their terminal 14) so that various marketing messages are delivered to the consumer based on at least one item of information about the consumer other than their response to a question delivered to the terminal 14. Thus, although the management system 18 has access to the same type of marketing messages as used in the prior art, e.g., an introduction, question and messages, it also has access to information about the consumer, e.g., from available databases, and utilizes this information when determining which of the marketing messages to send and their order. It is possible therefore that some consumers may not received the introduction, while others may not receive the question etc.

As mentioned above, marketing messages are delivered and presented to the consumer based on direct and/or indirect feedback which is used to optimize the determination of which marketing message(s) to send to the consumer and the order thereof. For example, if certain types of consumers are known to be highly likely to make a purchase upon receiving a coupon for a product or service, and this information is stored in a database, then the management system 18 can access this database and sends one or both messages, Message A and/or Message B, to the consumer. Delivery and presentation of an introduction about the advertised product or service and a question about which product or service the consumer is interested in are eliminated.

On the other hand, if a database contains information that certain consumers do not respond to the direct presentation of a coupon, then the management system 18 would not automatically send one or both messages to such consumers. Rather, the management system 18 may first deliver and present a question to each of these consumers, assuming the consumer is categorized as one whom frequently responds to messages, and only if the consumer responds to the question, would the management system 18 deliver and present one of the messages, Message A or Message B. Alternatively, the management system 18 may deliver and present only the introduction to the consumer if the consumer is categorized as one whom rarely responds to messages.

In this manner, a dynamic two-way messaging application is provided between a content delivery and presentation management system 18 and a consumer's mobile terminal 14 wherein there are multiple and different messages flows capable of being applied, with the specific message flow being applied being dependent on information about each consumer available to the management system 18.

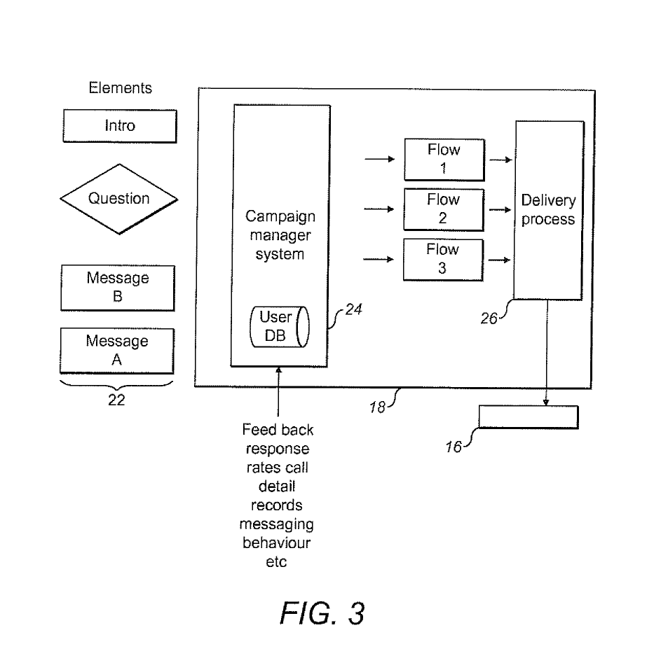

Referring to FIG. 3, in an exemplifying use of the system 10 in accordance with the invention, an advertiser 12 provides marketing messages 22 of an advertising campaign to the management system 18 via an Internet interface. The marketing messages 22 include an introduction, a question, an offer, a message, a supplement or follow-on, and other elements of the advertising campaign. One or more of each type of marketing message 22 may be provided, e.g., Messages A and B as shown in FIG. 3. The different marketing messages may be associated with different categories of consumers or different items of information about the consumers so that once a category or information about each consumer is obtained, the marketing message or messages suitable for that consumer, and an order of presentation, are identified.

The advertiser 12 may provide a program to the management system 18 that determines the manner in which the marketing messages should be presented based on consumer information. For example, in one embodiment, the management system 18 includes a program referred to as a campaign manager system (CMS) 24 which performs the selection and ordering of the marketing messages 22 in accordance with information about each consumer. This information may be obtained via direct feedback from the consumers or via indirect feedback, e.g., derived from historical success with delivering and presenting marketing messages to the consumers, detailed records of calls using the telecommunication infrastructure 16, etc. The CMS 24 may apply a marketing messages sorting, selection and ordering algorithm that creates multiple flows, e.g., Flow 1, Flow 2 and Flow 3, as marketing message flows for different consumers or groups of consumers depending on the parameters of the campaign. These message flows, and marketing message(s) constituting each, are then provided to a delivery system, module or application 26 which interacts with the telecommunication infrastructure 16 to cause the marketing messages 22 to be delivered and presented to the particular consumers based on set rules and parameters of the advertising campaign. Thus, depending on information about each consumer, Flow 1 may be applied to one consumer, Flow 2 applied to another consumer and Flow 3 to yet another consumer. The particular flow applied to each consumer depends on the information about the consumer, i.e., each consumer receives a customized flow of marketing messages 22.

After each marketing message is delivered and presented to the consumer, the management system 18 monitors the consumer's response, if the marketing messages is one which enables or prompts a response, and stores both the marketing message and the response, e.g., in a database 28 of the CMS 24. Information about the messages and responses thereto, along with information about consumers to whom messages are delivered and presented and the consumers which provided the responses, enables the advertiser to assess the advertising campaign and optimize the current and/or future advertising campaigns.

The management system 18 may be arranged to immediately apply information about which consumers responds to which marketing messages in order to alter the marketing messages being delivered and presented to consumers and/or the order thereof. For example, if it found after a certain period of time that one category of consumers ignore a particular message, then the management system 18 may be arranged to subsequently deliver and present a different marketing message to consumers in that category. The same applies to each consumer. For example, if it found that a particular consumer responds better to a question than directly receiving a marketing message with an offer, then the management system 18 may be arranged to subsequently direct a question to that consumer instead of a direct offer.

Since the management system 18 optimizes the selection, delivery and presentation of marketing messages to each consumer, i.e., to each consumer's terminal 14, the advertising campaign is considerably better than prior art advertising campaigns using two-way messaging in that it would obtain the positive and favorable responses to the advertising campaign.

Moreover, by simplifying the manner in which information about the consumers' responses to marketing messages is obtained, it becomes possible to better analyze this information for the purpose of creating subsequent advertising campaigns. That is, it might be found during one advertising campaign that consumers respond to a particular type of coupon campaign but not another, and therefore, the advertiser 12 can use this information to determine which advertising campaign to conduct. For example, consumers might respond better to a coupon campaign for movie tickets but not for hamburgers and thus an advertiser offering movie tickets would be inclined to conduct the coupon campaign while an advertiser offering hamburgers would not be so inclined.

Several computer programs resident on computer-readable media may be used in the invention. One computer program is resident in the management system 18 and controls the receipt, selection and delivery of the marketing messages to the consumer's terminal 14 and also manages the feedback about the consumers, while another is resident in the terminal 14. Some of the functions of the program in the management system 18 may be performed by the program resident in the terminal 14. In this case, the terminal 14 may receive marketing messages of the advertising campaign and commands to determine which to present to the consumer and the order thereof. The terminal 14 might also receive information about the consumer and then, based thereon, present specific marketing messages of the advertising campaign to the consumer in a specific order.

In the context of this document, computer-readable medium could be any means that can contain, store, communicate, propagate or transmit a program for use by or in connection with

the method, system, apparatus or device. The computer-readable medium can be, but is not limited to (not an exhaustive list), electronic, magnetic, optical, electromagnetic, infrared, or semi-conductor propagation medium. The medium can also be (not an exhaustive list) an electrical connection having one or more wires, a portable computer diskette, a random access memory (RAM), a read-only memory (ROM), an erasable, programmable, read-only memory (EPROM or Flash memory), an optical fiber, and a portable compact disk read-only memory (CDROM). The medium can also be paper or other suitable medium upon which a program is printed, as the program can be electronically captured, via for example, optical scanning of the paper or other medium, then compiled, interpreted, or otherwise processed in a suitable manner, if necessary, and then stored in a computer memory. Also, a computer program or data may be transferred to another computer-readable medium by any suitable process such as by scanning the computer-readable medium.

Having described exemplary embodiments of the invention with reference to the accompanying drawings, it will be appreciated that the present invention is not limited to those embodiments, and that various changes and modifications can be effected therein by one of ordinary skill in the art without departing from the scope or spirit of the invention as defined by the appended claims.

1. A system for presenting content from a content provider to a consumer, the content having multiple elements capable of being selectively presented to the consumer, the system comprising:
a management system arranged to receive information about the consumer and determine which elements to present to the consumer and an order of presentation based on the received information about the consumer; and
a presentation device arranged to receive information about which elements to present to the consumer and the order of presentation from said management system and present the elements in accordance therewith,
said presentation device being arranged to enable the consumer to provide information to said management system such that said management system and said presentation device engage in two-way communications.

2. The system of claim 1, wherein the content provider is an advertiser and the elements are marketing messages of an advertising campaign.

3. The system of claim 1, wherein at least one of the elements is a question which enables the consumer to provide a response, said presentation device being arranged to receive the consumer's response to the question and direct the consumer's response to said management system, the response being information based on which said management system determines which elements to present to the consumer and the order of presentation.

4. The system of claim 1, wherein said presentation device is a mobile terminal.

5. The system of claim 1, wherein said presentation device is an interactive television.

6. The system of claim 1, wherein said presentation device is arranged to provide information to said management system about the consumer derived directly from the consumer's browsing of the Internet, the consumer's purchasing actions and/or the consumer's response to one or more elements of the content.

7. The system of claim 1, wherein said management system is arranged to receive information about the consumer derived indirectly from the consumer's use and interaction with telecommunications infrastructure coupling said presentation device to said management system.

8. The system of claim 1, further comprising an interface to enable the content provider to access said management system to provide the content and determine rules and parameters for presentation of the content to the consumer.

9. The system of claim 1, wherein said management system is arranged to receive information about the consumer from a retail processing system which provides information about purchased products and/or services.

10. The system of claim 1, wherein said management system is arranged to categorize the consumer based on the information about the consumer and assign specific elements and an order of elements to each category of consumer.

11. The system of claim 1, wherein said management system includes a campaign manager system for ordering the elements in accordance with the received information about the consumer, said campaign manager system being arranged to apply an element selection, sorting and ordering algorithm to create multiple flows of elements and determine which flow to apply for the consumer based on the received information about the consumer.

12. The system of claim 11, wherein said management system further includes a database for storing response from the consumer to previously presented elements, said algorithm being applied based on information from said database.

13. The system of claim 11, wherein said management system further includes a delivery module to receive one of the flows from said campaign manager and deliver the elements to said presentation device in accordance with the received flow.

14. The system of claim 1, wherein said management system is arranged to obtain information about the consumer's response to the presentation of elements and use this information when subsequently determining which element or elements to present to the consumer and the order of presentation.

15. A management system for coordinating delivery of content from a content provider to a consumer, the content having multiple elements capable of being selectively delivered to the consumer, the management system comprising:
means for receiving information about the consumer;
means for determining which elements to present to the consumer and an order of presentation based on the received information about the consumer; and
means for communicating with the consumer to deliver the elements to be presented to the consumer in the determined order.

16. The management system of claim 15, wherein the content provider is an advertiser and the elements are marketing message of an advertising campaign.

17. The management system of claim 15, wherein at least one of the elements is a question which enables the consumer to provide a response, said means for receiving information about the consumer being arranged to receive the consumer's response to the question.

18. The management system of claim 15, wherein said means for receiving information are arranged to receive information about the consumer derived directly from the consumer's browsing of the Internet, the consumer's purchasing actions and/or the consumer's response to one or more elements of the content.

19. The management system of claim 15, wherein said means for receiving information are arranged to receive information about the consumer derived indirectly from the consumer's use and interaction with telecommunications infrastructure interacting with the management system.

20. The management system of claim 15, further comprising means for enabling the content provider to provide content for presentation to the consumer and determine rules and parameters for presentation of the content to the consumer.

21. The management system of claim 15, wherein said means for receiving information are arranged to receive information from a retail processing system which provides information about purchased products and/or services.

22. The management system of claim 15, further comprising means for categorizing the consumer based on the information about the consumer and assigning one or more specific elements and an order of elements to each category of consumer.

23. The management system of claim 15, wherein said means for determining comprise means for applying an element selection, sorting and ordering algorithm to create multiple flows of elements and for determining which flow to apply for the consumer based on the information about the consumer.

24. The management system of claim 23, further comprising means for storing response from the consumer to previously presented elements, said algorithm being applied based on information from said means for storing.

25. The management system of claim 23, further comprising means for receiving one of the flows from said means for applying and delivering the elements to said means for communicating in accordance with the received flow.

26. The management system of claim 15, wherein said means for receiving information are arranged to receive information about the consumer's response to presentation of the elements, said means for determining being arranged to use this response information when determining which element or elements to present to the consumer and the order of presentation.

27. A computer program or a suite of computer programs, embodied in a non-transitory computer-readable storage media, comprising a set of executable program instructions, wherein execution of said program instructions coordinates presentation of content from a content provider to a consumer, the content having multiple elements capable of being selectively presented to the consumer, the computer program product being arranged to:
receive information about the consumer; and
determine which elements to present to the consumer and an order of presentation based on the received information about the consumer.

28. The computer program of claim 27, wherein the computer program is further arranged to direct delivery of the elements to the consumer in the determined order.

29. The computer program of claim 27, wherein the computer program is further arranged to receive information about the consumer derived directly from the consumer's browsing of the Internet, the consumer's purchasing actions and/or the consumer's response to one or more elements of the content.

30. The computer program of claim 27, wherein the computer program is further arranged to receive information about the consumer derived indirectly from the consumer's use and interaction with telecommunications infrastructure used to deliver the elements to the consumer.

31. The computer program of claim 27, wherein the computer program is further arranged to enable the content provider to determine rules and parameters for presentation of the content to the consumer.

32. The computer program of claim 27, wherein the computer program is further arranged to receive information from a retail processing system which provides information about purchased products and/or services.

33. The computer program of claim 27, wherein the computer program is further arranged to categorize the consumer based on the information about the consumer and assign one or more specific elements and an order of elements to each category of consumer.

34. The computer program of claim 27, wherein the computer program is further arranged to create multiple flows of elements and determining which flow to apply for the consumer based on the information about the consumer.

35. The computer program of claim 27, wherein the computer program is further arranged to receive information about the consumer's response to presentation of the elements and use this response information when determining which element or elements to present to the consumer and the order of presentation.

36. A method for presenting content to a consumer's presentation device, comprising:
providing a plurality of predetermined elements constituting the content that can be presented to the consumer; and
varying which elements are presented to the consumer and/or an order of presentation of the elements to the consumer based on information about the consumer such that the elements and/or their order of presentation are customized for the consumer.

37. The method of claim 36, further comprising:
obtaining information abut the consumer directly from the consumer; and
using this information in order to determine how to vary the elements to present to the consumer and/or the order of presentation.

38. The method of claim 37, wherein the information is obtained directly from the consumer by presenting a question to the consumer and obtaining the consumer's response to the question, by presenting a message to the consumer with embedded links and determining which link the consumer activates, by analyzing web/WAP pages the consumer browses while surfing the Internet, by determining which coupons the consumer redeems and/or by presenting a marketing message to the consumer and obtaining the consumer's response to the marketing message.

39. The method of claim 36, further comprising:
obtaining information indirectly about the consumer from sources other than the consumer; and
using this information in order to determine how to vary the elements to present to the consumer and/or the order of presentation.

40. The method of claim 36, further comprising:
storing information about the consumer in a database; and
accessing the database in order to determine how to vary the elements to present to the consumer and/or the order of presentation.

41. The method of claim 36, further comprising:
delivering the elements to the consumer via telecommunications equipment;
obtaining information about the consumer by monitoring the consumer's interaction with and use of the telecommunications equipment; and
using this information in order to determine how to vary the elements to present to the consumer and/or the order of presentation.

42. The method of claim 36, wherein the elements are marketing messages forming an advertising campaign, further comprising maintaining a management system for managing presentation of the marketing messages to the consumer.

43. The method of claim 42, further comprising enabling a content provider to access 30 the management system to provide marketing messages and determine rules for presentation of the provided marketing messages to the consumer.

44. The method of claim 36, further comprising:
obtaining the information about the consumer from retail processing systems which process purchases by the consumer; and
using this information in order to determine how to vary the elements to present to the consumer and/or the order of presentation.

45. The method of claim 36, further comprising:
categorizing the consumer based on the information about the consumer; and
using the category of the consumer in order to determine how to vary the elements to present to the consumer and/or their order of presentation.

46. A system for presenting content to a consumer's presentation device, comprising:
means for providing a plurality of predetermined elements constituting the content that can be presented to the consumer; and
means for varying which elements are presented to the consumer and/or an order of presentation of the elements to the consumer based on information about the consumer such that the elements and/or their order of presentation are customized for the consumer.

47. The system of claim 46, wherein the elements are marketing messages of an advertising campaign.

48. The system of claim 46, further comprising means for obtaining information about the consumer directly from the consumer, said varying means being arranged to use this information in order to determine how to vary the elements to present to the consumer and/or the order of presentation.

49. The system of claim 46, further comprising means for obtaining information about the consumer from sources other than the consumer, said varying means being arranged to use this information in order to determine how to vary the elements to present to the consumer and/or the order of presentation.

50. The system of claim 46, further comprising means for storing information about the consumer, said varying means being arranged to access said storing means in order to determine how to vary the elements to present to the consumer and/or the order of presentation.

51. The system of claim 46, wherein the elements are delivered to the consumer via telecommunications equipment, further comprising means for obtaining information about the consumer by monitoring the consumer's interaction with and use of the telecommunications equipment, said varying means being arranged to use this information in order to determine how to vary the elements to present to the consumer and/or the order of presentation.

52. The system of claim 46, further comprising means for obtaining the information about the consumer from retail processing systems which process purchases by the consumer, said varying means being arranged to use this information in order to determine how to vary the elements to present to the consumer and/or the order of presentation.

53. The method of claim 46, further comprising means for categorizing the consumer based on information about the consumer, said varying means being arranged to use category of the consumer in order to determine how to vary the elements to present to the consumer and/or their order of presentation.
